(19) United States
(12) Patent Application Publication
(10) Pub. No.: US 2024/0381934 A1
(43) Pub. Date: Nov. 21, 2024

(54) STABLE ATOMIZATION HEATING UNIT, HEATING ASSEMBLY AND ATOMIZATION DEVICE

(71) Applicant: SHENZHEN HUACHENGDA PRECISION INDUSTRY CO. LTD., Shenzhen, Guangdong (CN)

(72) Inventor: Xiaodie Wang, Shenzhen, Guangdong (CN)

(21) Appl. No.: 18/272,364

(22) PCT Filed: Feb. 20, 2021
(86) PCT No.: PCT/CN2021/077046

§ 371 Date: Jul. 14, 2023

(51) Int. Cl. A24F 40/46; A24F 40/10; H05B 3/46

(52) U.S. Cl. CPC A24F 40/46; A24F 40/10; H05B 3/46

(57) ABSTRACT

The present invention provides a stable atomization heating unit, a heating assembly and an atomization device. The heating unit comprises an intermediate portion and end portions arranged respectively at two ends of the intermediate portion. The intermediate portion is connected to the end portions such that the heating unit heats when the end portions at the two ends are powered on, and an accommodating space is provided, in the heating unit, that runs through the end portions and the intermediate portion. The accommodating space has a smaller sectional area at the intermediate portion than at the end portions. The heating assembly comprises a liquid conducting body and the heating unit. The atomization device comprises a housing and the heating assembly. The housing is provided with a liquid channel and an air channel, and the liquid channel is communicated with the liquid conducting body.

### FIELD

The present invention relates to the technical field of heating units, and more specifically, to a stable atomization heating unit, a heating assembly and an atomization device.

### BACKGROUND

Currently, a heating atomization assembly mostly adopts a liquid conducting cotton, such as a liquid conducting cotton rope, as a liquid conducting body, and generally adopts a heating wire wrapped around the periphery of the liquid conducting cotton rope. The thickness of the liquid conducting cotton is consistent, the liquid conducting cotton is arranged in the inner hole of the heating unit, and the liquid is transmitted from both ends of the liquid conducting cotton to the heating unit. After electrified, the heating unit generates heat according to the thermal effect of the resistance, to atomize and evaporate the liquid.

However, the above structure may have the problems that, local part of the liquid conducting cotton may be subjected to oil explosion or core overburning, the atomization stability is poor, and the harmful substances may be generated, which will affect the consumer experience.

### SUMMARY

### Technical Problems

A technical problem to be solved by the present invention is, in view of the aforementioned defects in the prior art, to provide a stable atomization heating unit, a heating assembly and an atomization device.

Solutions of Problems

### Technical Solutions

A technical solution adopted by the present invention to solve the technical problem includes, to provide a heating unit, including an intermediate portion and end portions respectively arranged at two ends of the intermediate portion, wherein the intermediate portion is connected to the end portions, such that the heating unit generates heat when the end portions at the two ends are powered on, the heating unit is provided with an accommodating space running through the end portions and the intermediate portion, and

the accommodating space has a smaller sectional area at the intermediate portion than at the end portions.

Preferably, a radial dimension of the accommodating space at the intermediate position is smaller than a radial dimension of the accommodating space at the end portions in a first radial direction; a radial dimension of the accommodating space at the intermediate portion is smaller than a radial dimension of the accommodating space at the end portions in a second radial direction, and the first radial direction is not parallel to the second radial direction.

Preferably, a radial dimension of the accommodating space at the intermediate position is smaller than a radial dimension of the accommodating space at the end portions in a first radial direction; a radial dimension of the accommodating space at the intermediate portion is greater than or equal to a radial dimension of the accommodating space at the end portions, and the first radial direction is not parallel to the second radial direction.

Preferably, the sectional area of the accommodating space decreases gently from the end portions to the intermediate portion.

Preferably, the sectional area of the accommodating space decreases in a stepped manner from the end portions to the intermediate portion.

Preferably, the heating unit is spiral.

Preferably, the heating unit is formed by winding a heating wire.

Preferably, the heating unit is tubular, and the intermediate portion is provided with a hollow structure that penetrates into the accommodating space.

A technical solution adopted by the present invention to solve the technical problem includes, to provide a heating assembly, including a liquid conducting body and the aforementioned heating unit, wherein the liquid conducting body is arranged in the accommodating space and in contact with an inner side of the heating unit.

A technical solution adopted by the present invention to solve the technical problem includes, to provide an atomization device, including a housing and the aforementioned heating assembly, wherein the housing is provided with a liquid channel and an air channel, and the liquid channel is communicated with the liquid conducting body, such that the liquid conducting body conducts liquid to the heating unit for heating and atomizing.

### Beneficial Effects of the Invention

### Beneficial Effects

The implementation of the technical solution in the present invention provides at least the following beneficial effects: by means of the heating unit, the heating assembly and the atomization device, the heating unit can be in better contact with the liquid conducting cotton while satisfying the liquid supply, resulting in a good heating stability.

### BRIEF DESCRIPTION OF THE DRAWINGS

### Description of the Drawings

Subject matter of the present invention will be described in even greater detail below based on the exemplary figures. In the accompanying drawings:

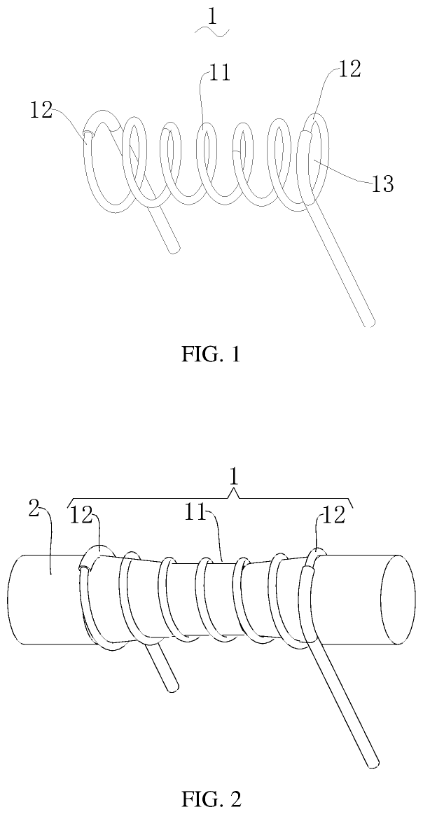

FIG. 1 is a three-dimensional view of a heating unit in a first embodiment of the present invention.

FIG. 2 is a three-dimensional view of a heating assembly, including a liquid conducting body and the heating unit in FIG. 1, in the first embodiment of the present invention.

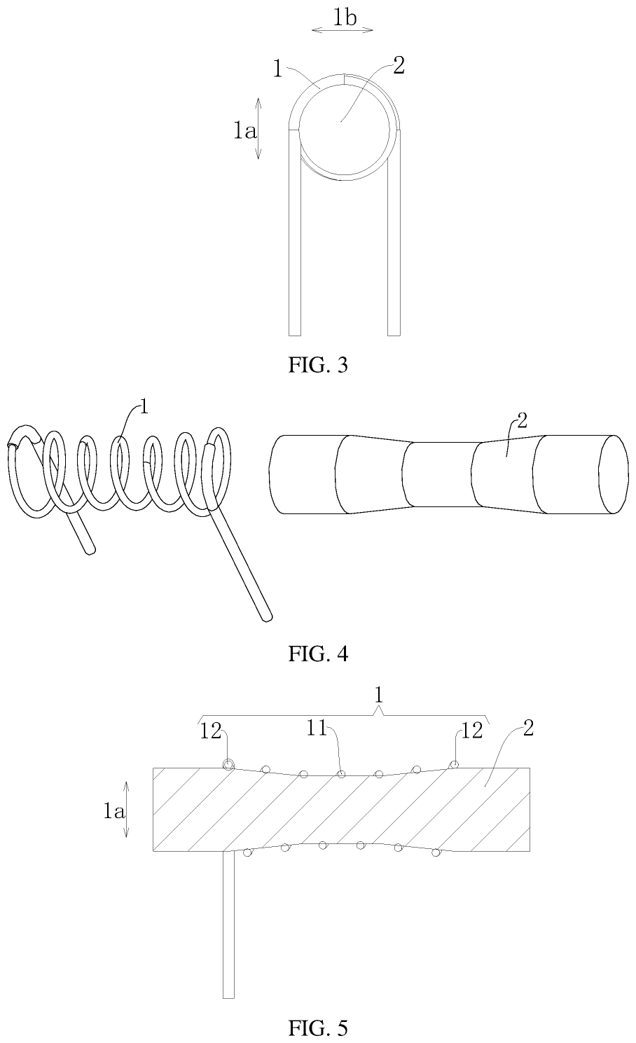

FIG. 3 is an orthographic view of the heating assembly in FIG. 2.

FIG. 4 is an exploded view of the heating assembly in FIG. 2.

FIG. 5 is a sectional view of the heating assembly in FIG. 2.

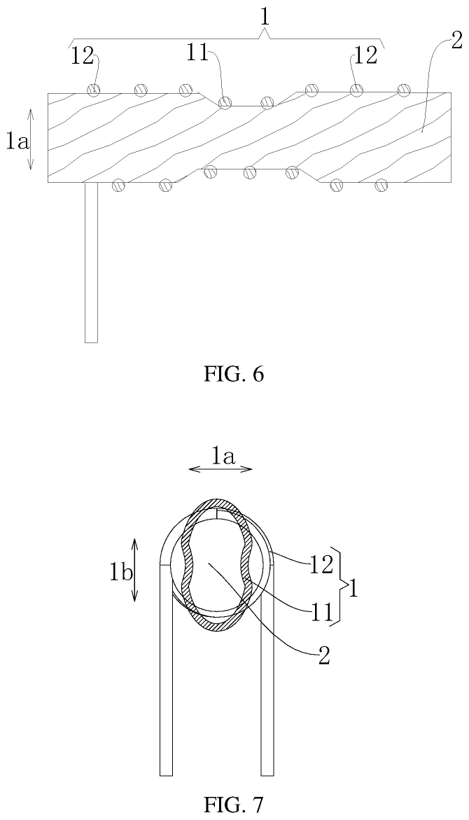

FIG. 6 is a sectional view of a heating assembly, including a liquid conducting body and a heating unit, in a second embodiment of the present invention.

FIG. 7 is a sectional view of a heating assembly, including a liquid conducting body and a heating unit, in a third embodiment of the present invention, wherein the shadow portion represents a projection of an intermediate portion of the heating unit.

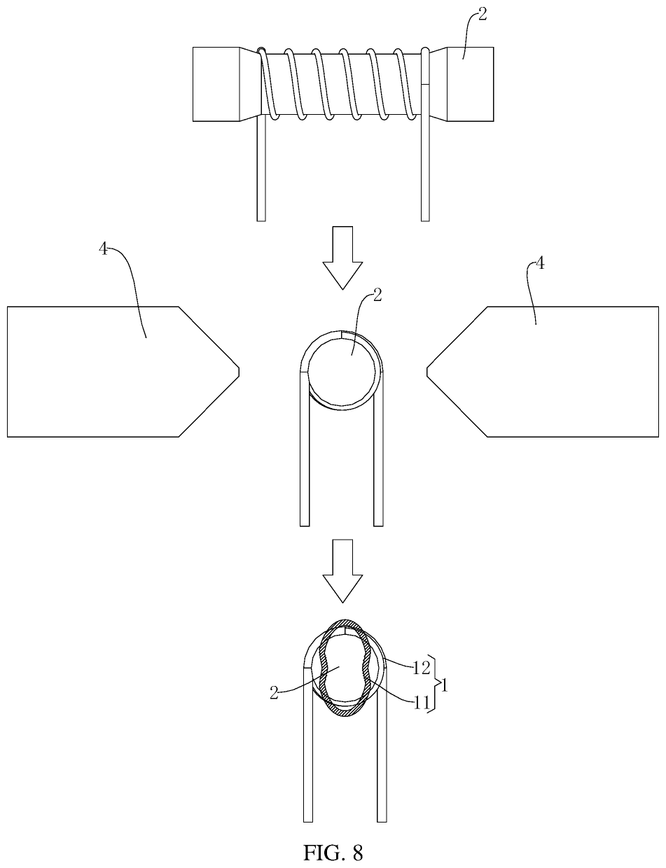

FIG. 8 is a flowchart of a manufacturing method of the heating assembly in FIG. 7, wherein the shadow portion represents the projection of the intermediate portion of the heating unit.

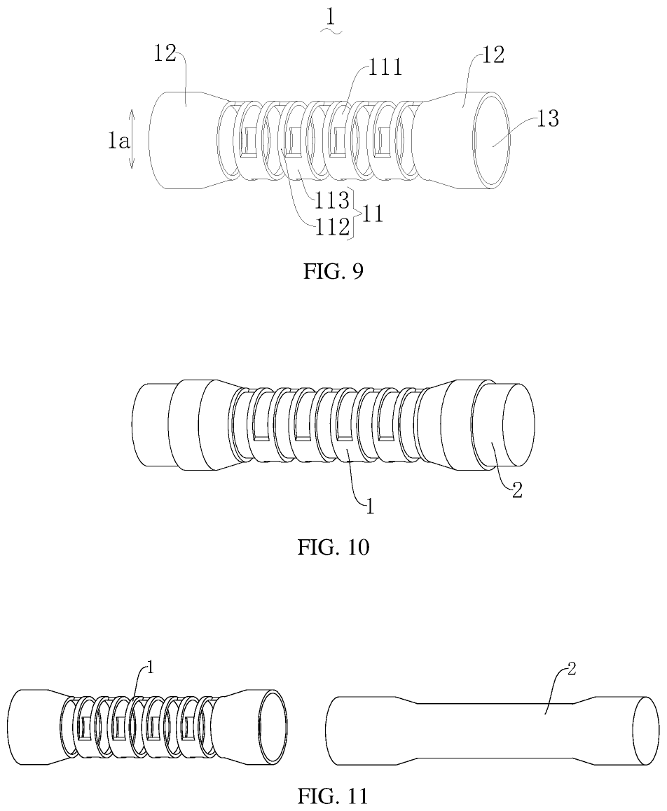

FIG. 9 is a three-dimensional view of a heating unit in a fourth embodiment of the present invention.

FIG. 10 is a three-dimensional view of a heating assembly, including a liquid conducting body and the heating unit in FIG. 9, in the fourth embodiment of the present invention.

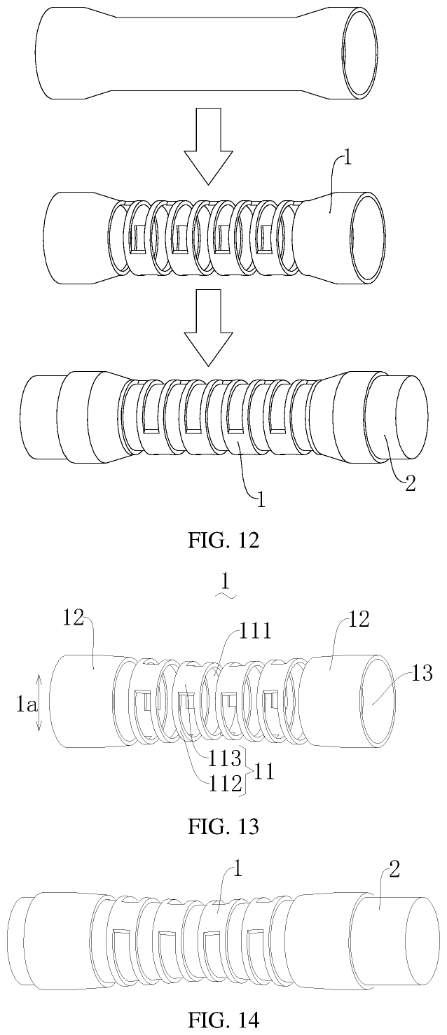

FIG. 11 is an exploded view of the heating assembly in FIG. 10.

FIG. 12 is a flowchart of a manufacturing method of the heating assembly in FIG. 10.

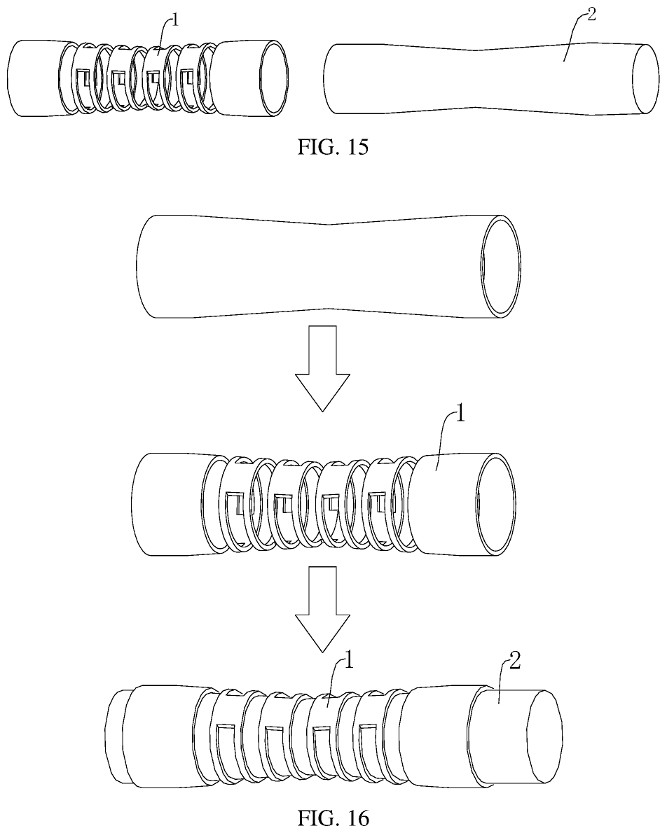

FIG. 13 is a three-dimensional view of a heating unit in a fifth embodiment of the present invention.

FIG. 14 is a three-dimensional view of a heating assembly, including a liquid conducting body and the heating unit in FIG. 13, in the fifth embodiment of the present invention.

FIG. 15 is an exploded view of the heating assembly in FIG. 14.

FIG. 16 is a flowchart of a manufacturing method of the heating assembly in FIG. 14.

FIG. 17 is a three-dimensional view of a heating unit in a sixth embodiment of the present invention.

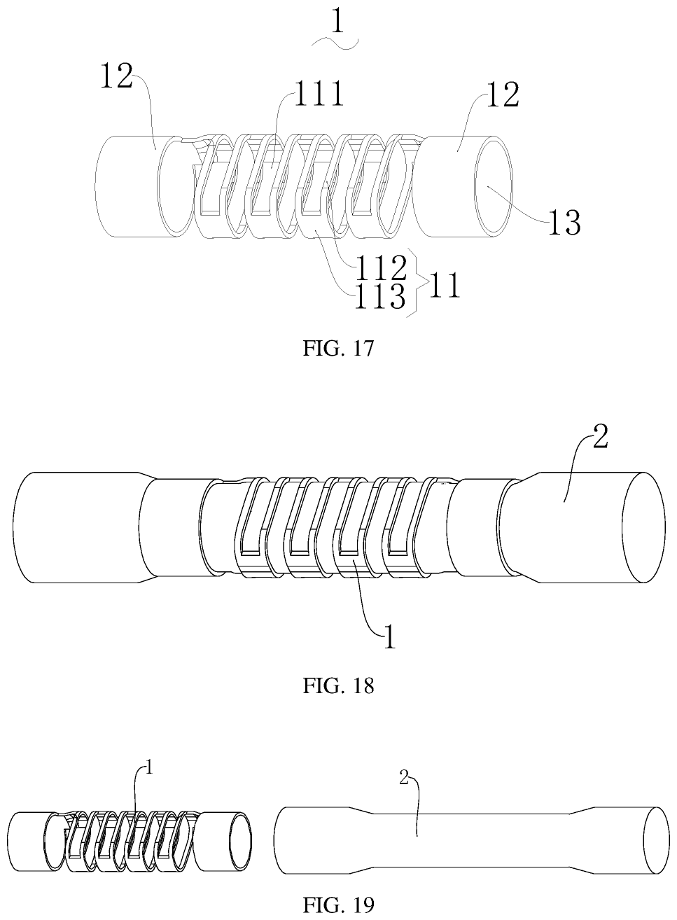

FIG. 18 is a three-dimensional view of a heating assembly, including a liquid conducting body and the heating unit in FIG. 17, in the sixth embodiment of the present invention.

FIG. 19 is an exploded view of the heating assembly in FIG. 18.

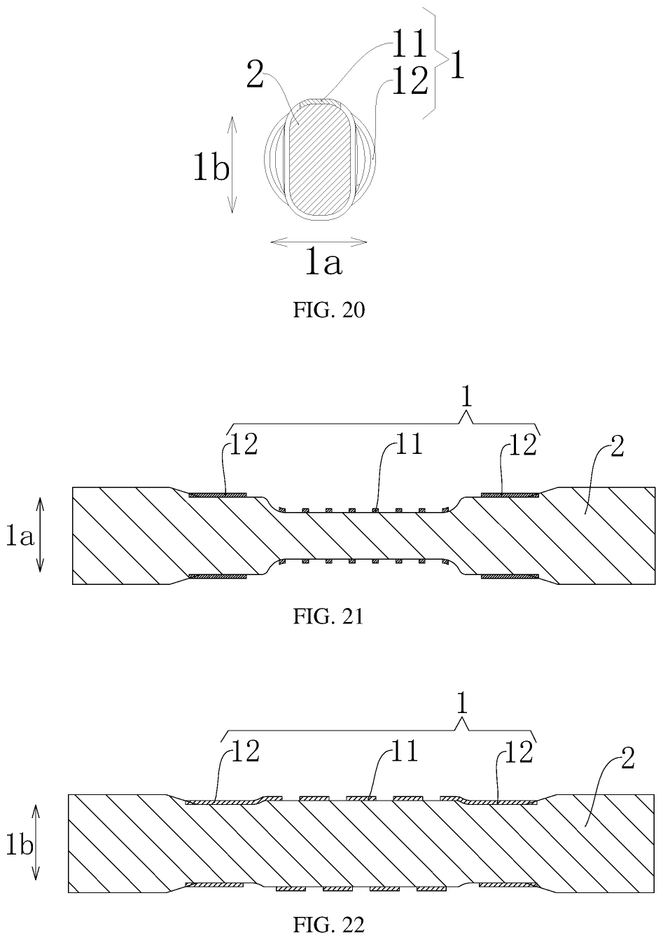

FIG. 20 is a sectional view of the heating assembly in FIG. 18.

FIG. 21 is a sectional view, in another direction, of the heating assembly in FIG. 18.

FIG. 22 is a sectional view, in yet another direction, of the heating assembly in

FIG. 18.

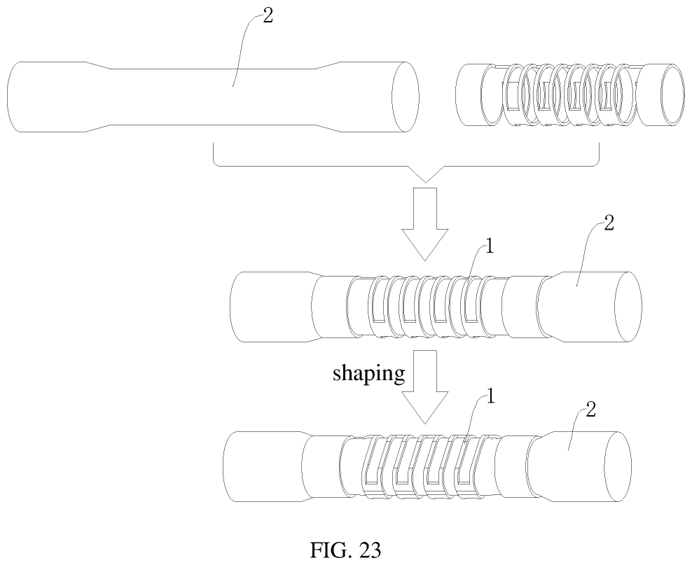

FIG. 23 is a flowchart of a manufacturing method of the heating assembly in FIG. 18.

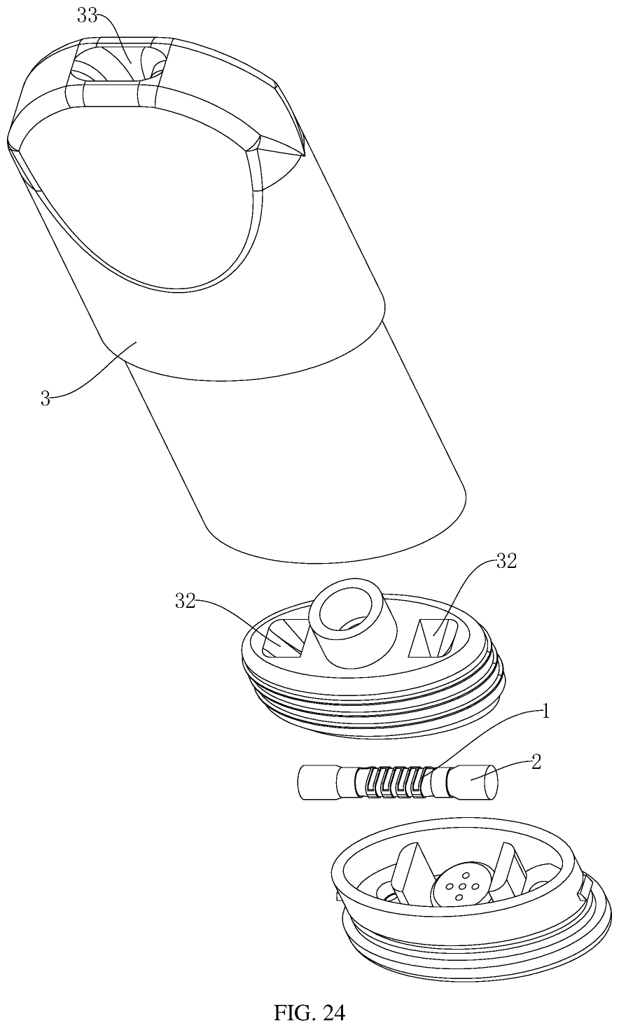

FIG. 24 is an exploded view of an atomization device in an embodiment of the present invention.

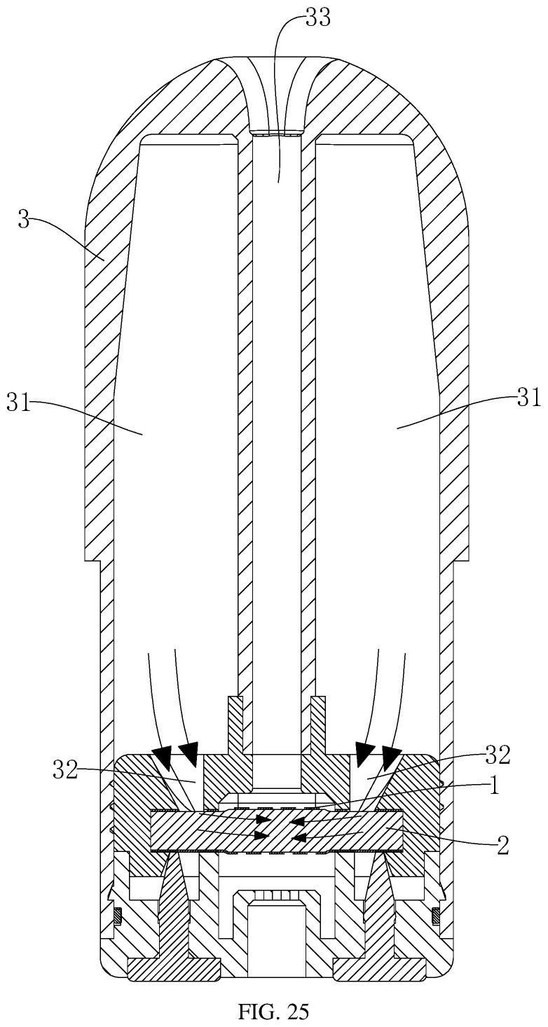

FIG. 25 is a sectional view of the atomization device in FIG. 24 (wherein the arrows indicate the liquid flow direction).

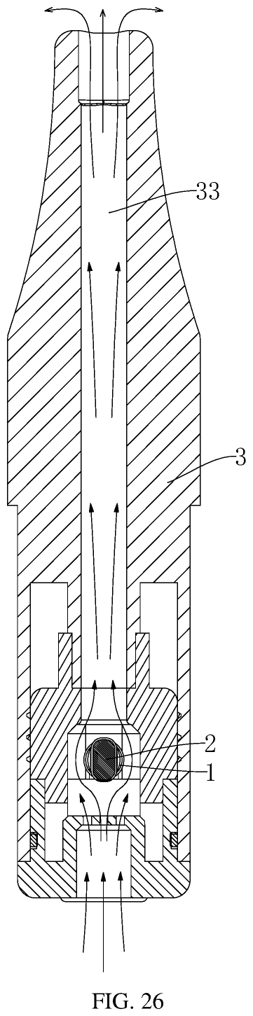

FIG. 26 is another sectional view of the atomization device in FIG. 24 (wherein the arrows indicate the flow direction of the atomized gas).

Wherein, the reference numerals in the figures represent: heating unit 1, intermediate portion 11, hollow structure 111, annular portion 112, connecting portion 113, end portion 12, accommodating space 13, first radial direction 1a, second radial direction 1b, liquid conducting body 2, housing 3, liquid storage chamber 31, liquid channel 32, air channel 33, shaping tool 4.

### DETAILED DESCRIPTION

### Description of the Invention

For better understanding of the technical features, objects and effects of the present invention, the specific embodiments of the present invention will be described in detail with reference to the accompanying drawings. It should be understood that the orientation or the position relationship indicated by relative terms such as “front”, “back”, “upper”, “lower”, “left”, “right”, “longitudinal”, “lateral”, “vertical”, “horizontal”, “top”, “bottom”, “inner”, “outer”, “head”, “tail” and the like are based on the directions or location relationships shown in the accompanying drawings, or the directions or location relationships that are usually placed or operated when the product is used, and are merely used for the convenience of describing the present invention, but are not used to indicate or imply that the referred apparatus or element needs to be constructed or operated in a particular orientation, and therefore, cannot be understood as a limitation to the present invention. It should be further noted that, in the present invention, unless specified or limited otherwise, the terms “mounted”, “connected”, “coupled”, “fixed”, “arranged” and the like should be understood in a broad sense, for example, the connection may be a fixed connection, a detachable connection, or an integral connection; or the connection may be a direct connection, or an indirect connection through an intermediary, or the connection may be an internal communication between two elements or a mutual action relationship between two elements, unless otherwise specified explicitly. When one element is described to be located “above” another element, it means that the element may be “directly” or “indirectly” located above another element, or there may be one or more intervening element located therebetween. The terms “first”, “second”, “third” and the like are only used for the convenience of describing the technical solution, and cannot be understood as indicating or implying the relative importance or implicitly indicating the number of the indicated technical features. Therefore, features defined with “first”, “second”. “third”, etc. may explicitly or implicitly indicates that one or more of these features may be included. For those of ordinary skill in the art, the specific meaning of the above-mentioned terms in the present invention can be understood according to specific circumstances.

In the description hereinbelow, for purposes of explanation rather than limitation, specific details such as specific systematic architectures and techniques are set forth in order to provide a thorough understanding of the embodiments of the present invention. However, it will be apparent to persons skilled in the art that the present invention may also be implemented in absence of such specific details in other embodiments. In other instances, detailed descriptions of well-known systems, devices, circuits, and methods are omitted so as not to obscure the description of the present invention with unnecessary detail.

Through research, it is found that the main reasons for the problems in the background technology are as follows:

1. The liquid conducting cotton rope is arranged in the inner hole of the heating unit, due to that the inner diameters of the intermediate section and the two ends of the heating unit are the same, and the diameter of the liquid conducting cotton rope is also consistent, if the liquid conducting cotton is arranged in the inner hole too tightly, the inner walls at the two ends of the heating unit will limit the gaps of the liquid conducting cotton, causing the liquid supply to the intermediate section of the heating unit to slow down. While the temperatures in the intermediate section of the heating unit are higher than the temperatures at the two ends according to the principles of heat conduction and heat radiation, so that an insufficient liquid supply in the intermediate section is easily occurred, thereby resulting in a high atomization temperature to cause core overburning and generate harmful substances.

2. If the liquid conducting cotton rope is relatively loose in the inner hole of the heating unit, the liquid conducting cotton is relatively fluffy and has a good liquid conducting performance, which can meet the liquid supply in the intermediate section. However, due to the soft nature of the liquid conducting body such as the liquid conducting cotton, its appearance is irregular. Therefore, when the liquid conducting cotton rope and the heating unit are loosely matched, a local position where the heating unit and the cotton rope are not in contact may exist, which will cause oil frying and core overburning during use, affecting the consumer experience.

To solve the above-mentioned problems, the present invention provides a stable atomization heating unit, a heating assembly, and an atomization device.

Referring to FIG. 1 to FIG. 23, the heating unit 1 in some embodiments of the present invention includes an intermediate portion 11 and end portions 12 located at two ends of the intermediate portion 11. The intermediate portion 11 is connected to the end portions 12, so that the heating unit 1 generates heat according to the thermal effect of resistance when the end portions 12 at the two ends are powered on. An accommodating space 13 that is configured for accommodating the liquid conducting body 2 and runs through the end portions 12 and the intermediate portion 11 is provided in the heating unit 1.

The accommodating space 13 has a smaller sectional area at the intermediate portion 11 than at the end portions 12.

The accommodating space 13 of the heating unit 1 has a larger sectional area at the end portions 12 and a smaller sectional area at the intermediate portion 11 (resulting in that the accommodating space 13 of the heating unit 1 has a larger space at the two ends and a smaller space at the intermediate). Generally, the diameter of the liquid conducting body 2 is uniform, so that when the liquid conducting body 2 is arranged in the accommodating space 13 of the heating unit 1, the heating unit 1 and the liquid conducting body 2 have a relatively loose fit at the two ends and a relatively tight fit at the intermediate, so that the heating unit 1 can be in better contact with the liquid conducting cotton while satisfying the liquid supply, resulting in a good heating stability. The heating unit 1 can be applied to the atomization device.

In some embodiments, as shown in FIG. 1 to FIG. 5 and FIG. 9 to FIG. 16, the radial dimension of the accommodating space 13 at the intermediate portion 11 is smaller than the radial dimension of the accommodating space 13 at the end portion 12 in a first radial direction 1a; and in a second radial direction 1b, the radial dimension of the accommodating space 13 at the intermediate portion 11 may be smaller than the radial dimension of the accommodating space 13 at the end portion 12, and the first radial direction 1a is not parallel to the second radial direction 1b.

In some other embodiments, as shown in FIG. 7 to FIG. 8 and FIG. 17 to FIG. 23, in the first radial direction 1a, the radial dimension of the accommodating space 13 at the intermediate portion 11 is smaller than the radial dimension of the accommodating space 13 at the end portion 12; and in the second radial direction 1b, the radial dimension of the accommodating space 13 at the intermediate portion 11 may also be greater than or equal to the radial dimension of the accommodating space 13 at the end portion 12, and the first radial direction 1a is not parallel to the second radial direction 1b.

Wherein, the sectional area is the area of the section perpendicular to the through direction of the accommodating space, and the radial direction is perpendicular to the through direction of the accommodating space.

Preferably, the first radial direction 1a and the second radial direction 1b are perpendicular to the through direction of the accommodating space 13, and the first radial direction 1a is perpendicular to the second radial direction 1b.

FIG. 1 to FIG. 23 show various different structures of the heating unit 1, which may have a spiral structure (see FIG. 1 to FIG. 8), or a tubular structure (see FIG. 9 to FIG. 23).

As shown in FIG. 1 to FIG. 5, the heating unit 1 is in a spiral shape. The heating unit 1 may be made by winding a heating wire. In some embodiments, as shown in FIG. 1 to FIG. 5, when the heating unit 1 adopts a filamentous spiral structure, the heating wire may be wound into a spiral shape with a small inner diameter in the intermediate portion and a large inner diameter at the two ends, and then the liquid conducting body 2 is inserted into the accommodating space 13 of the heating unit 1, forming a structure where the heating unit 1 is wound around the outer side of the liquid conducting body 2.

In other embodiments, as shown in FIG. 7 to FIG. 8, this structure may be formed by using a regular cylindrical spiral heating body, and formed by squeezing the intermediate portion 11 of the heating unit 1 with a shaping tool 4, thereby achieving a good contact between the heating unit 1 and the liquid conducting body 2. In this way, the implementation is simple and convenient, the dimension is controllable, and large-batch automated production can be achieved.

As shown in FIG. 9 to FIG. 12, the heating unit 1 is in a tubular shape, and the intermediate portion 11 is provided with a hollow structure 111 that penetrates from the outside to the accommodating space 13. The intermediate portion 11 may include annular portions 112 and a connecting portion 113, where the number of the annular portions 112 is at least two. The annular portions 112 are spaced in the through direction of the accommodating space 13, adjacent two annular portions 112 are connected through the connecting portion 113, and adjacent two connecting portions 113 are staggered in the circumferential direction.

In some embodiments, as shown in FIG. 12, a tubular metal with a small intermediate portion 11 and a large end portion 12 may be formed by stretching, and then a tubular heating unit 1 with a hollow structure 111 may be obtained through a process such as etching, cutting, or stamping, etc.

In other embodiments, as shown in FIG. 17 to FIG. 23, the heating unit 1 adopts a tubular heating body. After the manufacturing is completed, the liquid conducting body 2 is inserted into the accommodating space 13 of the tubular heating body, and then the circular tubular heating body is pressed into a runway shape, an elliptical shape, a rectangle shape or other shape using the shaping tool. According to that the area of the circle is the maximum under a certain perimeter, the intermediate portion 11 of the heating area of the heating unit 1 is shaped into a runway shape, an elliptical shape, a rectangle shape or other shape, such that the inner section area of the intermediate heating area of the heating unit 1 is smaller than that of the end portions 12, therefore the cotton in the intermediate portion 11 will be relatively dense and in the end portions 12 will be relatively loose when the heating unit 1 is matched with the liquid conducting body 2, achieving the effect of fast liquid feeding at the end portions 12 and a good contact at the intermediate portion.

In the above embodiments, as shown in FIG. 1 to FIG. 5 and FIG. 13 to FIG. 16, the transition from the end portion 12 to the intermediate portion 11 presents an inclined shape, and the sectional area of the accommodating space 13 may decrease gently from the end portion 12 to the intermediate portion 11.

In addition, in the above embodiments, as shown in FIG. 6 and FIG. 9 to FIG. 12, the sectional area of the accommodating space 13 may also decrease in a stepped manner from the end portion 12 to the intermediate portion 11.

The heating assembly of the present invention includes the liquid conducting body 2 and the aforementioned heating unit 1. As shown in FIG. 1 to FIG. 23, the aforementioned various embodiments of the combined structure of the heating unit 1 and the liquid conducting body are presented, where the liquid conducting body 2 is arranged in the accommodating space 13 of the heating unit 1 and in contact with the inner side of the heating unit 1.

When the heating assembly is used for atomization, liquid conducting body 2 comes into contact with the liquid and conducts the liquid to heating unit 1 for atomization.

The liquid conducting body 2 may adopt a liquid conducting cotton, such as a liquid conducting cotton rope. The heating assembly adopts the aforementioned heating unit 1, which has a larger sectional area at the end portions 12 and a smaller sectional area at the intermediate portion 11 (such that the accommodating space 13 of the heating unit 1 has a larger space at the two ends and a smaller space at the intermediate). Generally, the diameter of the liquid conducting body 2 is uniform, so that when the liquid conducting body 2 is arranged in the accommodating space 13 of the heating unit 1, the heating unit 1 and the liquid conducting body 2 have a relatively loose fit at the two ends and a relatively tight fit at the intermediate, so that the heating unit 1 can be in better contact with the liquid conducting cotton while satisfying the liquid supply, resulting in a good heating stability.

Referring to FIG. 24 to FIG. 26, an atomization device in an embodiment of the present invention includes a housing 3 and the aforementioned heating assembly. The housing 3 is provided therein with a liquid storage chamber 31, and is provided with a liquid channel 32 and an air channel 33. The liquid channel 32 is communicated with the liquid storage chamber 31 and the liquid conducting body 2, so that the liquid conducting body 2 conducts the liquid to the heating unit 1 for heating and atomizing. The atomization device adopts the aforementioned heating assembly, where the heating unit 1 has a larger sectional area at the end portions 12 and a smaller sectional area at the intermediate portion 11 (such that the accommodating space of the heating unit has a larger space at the two ends and a smaller space at the intermediate). Generally, the diameter of the liquid conducting body 2 is uniform, so that when the liquid conducting body 2 is arranged in the accommodating space 13 of the heating unit 1, the heating unit 1 and the liquid conducting body 2 have a relatively loose fit at the two ends and a relatively tight fit at the intermediate, so that the heating unit 1 can be in better contact with the liquid conducting cotton while satisfying the liquid supply, resulting in a good heating stability.

The atomization device can be used in an electronic cigarette, where the liquid storage chamber 31 is used to store the e-liquid, which contacts the liquid conducting body 2 through the liquid channel 32, and is transmitted to the heating unit 1 through the liquid conducting body 2 for heating and atomizing.

The above descriptions are only preferred embodiments of the present invention, and are not intended to limit the present invention. For those skilled in the art, the present invention may have various modifications, combinations and changes. Any modification, equivalent replacement, improvement, etc. made within the spirit and principle of the present invention shall be included within the scope of the claims of the present invention.

1. A heating unit (1), comprising:
an intermediate portion (11); and
end portions (12) respectively arranged at two ends of the intermediate portion (11),
wherein the intermediate portion (11) is connected to the end portions (12), such that the heating unit (1) generates heat when the end portions (12) at the two ends are powered on,
wherein the heating unit (1) is provided with an accommodating space (13) running through the end portions (12) and the intermediate portion (11), and
wherein the accommodating space (13) has a smaller sectional area at the intermediate portion (11) than at the end portions (12).

2. The heating unit (1) of claim 1, wherein a radial dimension of the accommodating space (13) at the intermediate position (11) is smaller than a radial dimension of the accommodating space (13) at the end portions (12) in a first radial direction (1a),
wherein a radial dimension of the accommodating space (13) at the intermediate portion (11) is smaller than a radial dimension of the accommodating space (13) at the end portions (12) in a second radial direction (1b), and
wherein the first radial direction (1a) is not parallel to the second radial direction (1b).

3. The heating unit (1) of claim 1, wherein a radial dimension of the accommodating space (13) at the intermediate position (11) is smaller than a radial dimension of the accommodating space (13) at the end portions (12) in a first radial direction (1a),
wherein a radial dimension of the accommodating space (13) at the intermediate portion (11) is greater than or equal to a radial dimension of the accommodating space (13) at the end portions (12), and
wherein the first radial direction (1a) is not parallel to the second radial direction (1b).

4. The heating unit (1) of claim 1, wherein the sectional area of the accommodating space (13) decreases gently from the end portions (12) to the intermediate portion (11).

5. The heating unit (1) of claim 1, wherein the sectional area of the accommodating space (13) decreases in a stepped manner from the end portions (12) to the intermediate portion (11).

6. The heating unit (1) of claim 1, wherein the heating unit (1) is spiral.

7. The heating unit (1) of claim 4, wherein the heating unit (1) is formed by winding a heating wire.

8. The heating unit (1) of claim 1, wherein the heating unit (1) is tubular, and the intermediate portion (11) is provided with a hollow structure (111) that penetrates into the accommodating space (13).

9. A heating assembly, comprising:
a liquid conducting body (2); and
the heating unit (1) of claim 1,
wherein the liquid conducting body (2) is arranged in the accommodating space (13) and in contact with an inner side of the heating unit (1).

10. An atomization device, comprising:
a housing (3); and
the heating assembly of claim 9,
wherein the housing (3) is provided with a liquid channel (32) and an air channel (33), and
wherein the liquid channel (32) is communicated with the liquid conducting body (2), such that the liquid conducting body (2) conducts liquid to the heating unit (1) for heating and atomizing.

11. The heating assembly of claim 9, wherein a radial dimension of the accommodating space (13) at the intermediate position (11) is smaller than a radial dimension of the accommodating space (13) at the end portions (12) in a first radial direction (1a),
wherein a radial dimension of the accommodating space (13) at the intermediate portion (11) is smaller than a radial dimension of the accommodating space (13) at the end portions (12) in a second radial direction (1b), and
wherein the first radial direction (1a) is not parallel to the second radial direction (1b).

12. The heating assembly of claim 9, wherein a radial dimension of the accommodating space (13) at the intermediate position (11) is smaller than a radial dimension of the accommodating space (13) at the end portions (12) in a first radial direction (1a),
wherein a radial dimension of the accommodating space (13) at the intermediate portion (11) is greater than or equal to a radial dimension of the accommodating space (13) at the end portions (12), and
wherein the first radial direction (1a) is not parallel to the second radial direction (1b).

13. The heating assembly of claim 9, wherein the sectional area of the accommodating space (13) decreases gently from the end portions (12) to the intermediate portion (11), or
wherein the sectional area of the accommodating space (13) decreases in a stepped manner from the end portions (12) to the intermediate portion (11).

14. The heating assembly of claim 9, wherein the heating unit (1) is spiral.

15. The heating assembly of claim 9, wherein the heating unit (1) is tubular, and the intermediate portion (11) is provided with a hollow structure (111) that penetrates into the accommodating space (13).

16. The atomization device of claim 10, wherein a radial dimension of the accommodating space (13) at the intermediate position (11) is smaller than a radial dimension of the accommodating space (13) at the end portions (12) in a first radial direction (1a),
wherein a radial dimension of the accommodating space (13) at the intermediate portion (11) is smaller than a radial dimension of the accommodating space (13) at the end portions (12) in a second radial direction (1b), and
wherein the first radial direction (1a) is not parallel to the second radial direction (1b).

17. The atomization device of claim 10, wherein a radial dimension of the accommodating space (13) at the intermediate position (11) is smaller than a radial dimension of the accommodating space (13) at the end portions (12) in a first radial direction (1a),
wherein a radial dimension of the accommodating space (13) at the intermediate portion (11) is greater than or equal to a radial dimension of the accommodating space (13) at the end portions (12), and
wherein the first radial direction (1a) is not parallel to the second radial direction (1b).

18. The atomization device of claim 10, wherein the sectional area of the accommodating space (13) decreases gently from the end portions (12) to the intermediate portion (11), or
wherein the sectional area of the accommodating space (13) decreases in a stepped manner from the end portions (12) to the intermediate portion (11).

19. The atomization device of claim 10, wherein the heating unit (1) is spiral.

20. The atomization device of claim 10, wherein the heating unit (1) is tubular, and the intermediate portion (11) is provided with a hollow structure (111) that penetrates into the accommodating space (13).
